(19) United States
(12) Patent Application Publication
(10) Pub. No.: US 2016/0108963 A1
(43) Pub. Date: Apr. 21, 2016

(54) ROLLING BEARING CAGE FOR A RADIAL BEARING

(71) Applicant: SCHAEFFLER TECHNOLOGIES AG & CO. KG, Herzogenaurach (DE)

(72) Inventors: Wilhelm Sebald, Bad Konigshofen (DE); Johannes Bedenk, Theres (DE)

(73) Assignee: Schaeffler Technologies AG &Co.KG, Herzogenaurach (DE)

(21) Appl. No.: 14/779,692

(22) PCT Filed: Feb. 13, 2014
(86) PCT No.: PCT/DE2014/200058

§ 371 Date: Sep. 24, 2015

(30) Foreign Application Priority Data
Apr. 25, 2013 (DE) 10 2013 207 494.8

(51) Int. Cl. F16C 33/66; F16C 19/26; F16C 33/46

(52) U.S. Cl. CPC F16C 33/6681; F16C 33/4629; F16C 33/4605; F16C 19/26

(57) ABSTRACT

A rolling bearing for a radial bearing, in particular a cylindrical roller bearing, including a number of cage pockets (8), each intended for receiving a rolling element (6), circumferential edge strips (10, 11) which are connected to each other by webs (12, 13) to form the cage pockets (8), wherein at least one of the edge strips (10) has an end-face section of reduced wall thickness designed as an oil-collecting ring (9), a first type of oil-guiding grooves (14, 15) running parallel to the webs (12, 13) at the inner circumference of at least one edge strip (10, 11), from which grooves a respective radial bore (17) extends to the outer circumference of the edge strip (10, 11), and a second type of oil-guiding grooves (16) running at the inner circumference of at least one edge strip (10, 11), which each extend from the oil-collecting ring (9) to a cage pocket (8).

### FIELD OF THE INVENTION

### Background

The invention relates to a rolling bearing cage that is suitable for a radial bearing and has structural features that influence the distribution of lubricant.

From DE 10 2008 004 970 A1, a rim-guided cage of a rolling bearing is known, wherein both the cage and also a bearing ring of the rolling bearing have a guiding surface. One of these guiding surfaces, namely an outer guiding surface, has a profile to feed lubricant within the rolling bearing. The profile can be shaped, for example, in the form of channels, grooves, or notches. Grease can be used as the lubricant for the rolling bearing formed, for example, as a ball bearing, cylindrical roller bearing, or conical roller bearing, according to DE 10 2008 004 970 A1.

### SUMMARY

The invention is based on the object of improving a rolling bearing cage that is suitable, in particular, for high rotational speeds, with regard to the lubricant feed compared with the cited prior art.

This object is achieved by a rolling bearing cage with one or more features of the invention. Advantageous improvements are the subject matter of the dependent claims. The rolling bearing cage is suitable, in particular, for use in a rolling bearing for supporting shafts, for example, intermediate shaft bearings, in a gas turbine.

The rolling bearing cage comprises
a number of cage pockets, which are each provided for holding a rolling element,
circumferential edge strips that are connected to each other by webs to form cage pockets, wherein at least one of the edge strips has an end-side section formed as an oil-collecting ring of reduced wall thickness,
oil-guiding grooves of a first type running on the inner circumference of at least one edge strip parallel to the webs, wherein a radial bore hole extends from each of these grooves to the outer circumference of the edge strip,
oil-guiding grooves of a second type running on the inner circumference of at least one edge strip, wherein each of these grooves extend from the oil-collecting ring to a cage pocket.

The invention starts from the idea that the feeding of lubricant in the direction toward the radial outer surface of the rolling bearing cage is very important in applications with high rotational speeds, wherein sufficient flow through the rolling bearing in the axial direction must also be provided at the same time.

This feeding of lubricant outward in the radial direction, as well as in the axial direction, that is, in the direction parallel to the rotational axis of the rolling bearing, is realized according to the invention in that lubricant, in particular, oil, fed to the rolling bearing from the outside first contacts a special oil-collecting ring that forms a widening of an edge strip of the cage. The lubricant flows at least partially in the axial direction outward from this oil-collecting ring to the surface of the rolling bearing cage, wherein for this purpose there are at least two different types of oil-guiding grooves that extend to different extents in the axial direction.

The oil-guiding grooves of the first type each opening into a radial bore hole preferably run in the circumferential sections of the cage where there is also a web separating two cage pockets from each other. Just like the oil-guiding grooves of the first type, the oil-guiding grooves of the second type supplying the cage pockets with oil also run preferably exactly in the axial direction, that is, parallel to the rotational axis of the rolling bearing cage. Deviating from this arrangement, oil-guiding grooves of the first and/or second type set at an angle can also be realized. In all cases, the oil-guiding grooves are on the inner side of the overall essentially cylindrical rolling bearing cage.

In a preferred construction, the rolling bearing cage has an oil-collecting ring only on a single end side, so that it thus has an asymmetric shape. According to this construction, the oil-guiding grooves of the first type comprise both oil-guiding grooves of a first sub-type and also oil-guiding grooves of a second sub-type, wherein the oil-guiding grooves of the second sub-type are longer than the oil-guiding grooves of the first sub-type and the radial bore holes starting from the oil-guiding grooves of the first sub-type pass through one of the two edge strips, while the radial bore holes starting from the oil-guiding grooves of the second sub-type pass through the second edge strip farther removed from the oil-collecting ring. The latter oil-guiding grooves engage in both edge strips, wherein they project past the cage pockets on both sides to differing degrees and border the oil-collecting ring on one side.

According to one advantageous improvement, individual webs are reinforced inward in the radial direction, while other webs are not reinforced. The webs extending farther inward reduce leakage losses and contribute to increasing the oil feed efficiency by feeding oil in the circumferential direction of the rolling bearing.

The reinforced webs are arranged, according to this refinement, preferably in the axial extension of an oil-guiding groove of the first sub-type, while an oil-guiding groove of the second sub-type is arranged on the inner circumference of a non-reinforced web. Reinforced webs and non-reinforced webs preferably alternate with each other. The number of oil-guiding grooves of the first sub-type, which is identical to the number of oil-guiding grooves of the second sub-type, is thus half as large as the number of oil-guiding grooves of the second type leading to the cage pockets.

With regard to their cross sections, the oil-guiding grooves of the different types and optionally of the sub-types can differ from each other. For example, the oil-guiding grooves of the second type, which supply the rolling elements arranged in the cage pockets and thus their raceways with lubricant, are formed for feeding a smaller quantity of lubricant than the oil-guiding grooves of the first type, which are used to lubricate the cage guiding surfaces.

The rolling bearing cage is preferably made from metal; in principle, however, it could also be made from plastic. In all of the cases, they are preferably outer rim-guided cages. The rolling elements guided in the cage are preferably cylindrical rollers.

The advantage of the invention is a defined and efficient feeding of lubricating oil onto the raceway of the rolling elements and onto the cage guiding surfaces, in particular, for rolling bearings operating at high rotational speeds and high thermal loads (and those susceptible to slip) with a rolling bearing cage guided by the outer rims of a bearing ring also for the feeding of lubricating oil on only one side.

### BRIEF DESCRIPTION OF THE DRAWINGS

An embodiment of the invention is described below with reference to a drawing. Shown herein are:

FIG. 1 a rolling bearing formed as a cylindrical roller bearing, in section, with a cage, and

FIG. 2 a detail of the rolling bearing cage from FIG. 1.

### DETAILED DESCRIPTION OF THE PREFERRED EMBODIMENTS

A rolling bearing marked overall with the reference symbol 1, namely a cylindrical roller bearing, has an outer ring 2 with two rims 3, 4, a rolling bearing cage 5 formed as a window cage, and a number of rolling elements 6, namely cylindrical rollers, guided in this cage. The axis of the rolling bearing 1 formed as a radial bearing, which is identical to the axis of symmetry of the rolling bearing cage 5, is marked with A. For the principle functioning of the rolling bearing 1, refer to the prior art cited above.

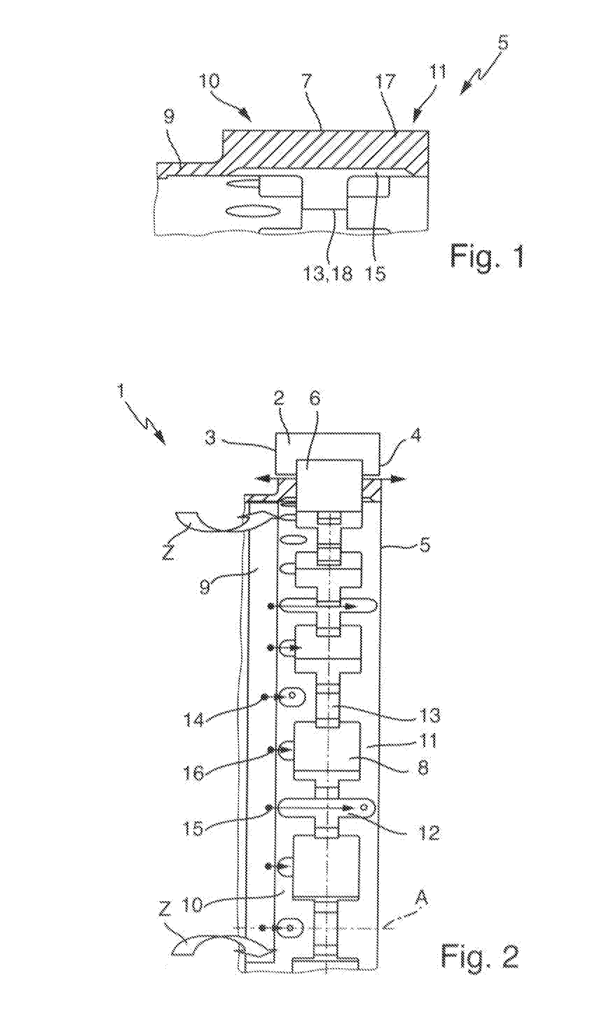

The rolling bearing cage 5 has overall essentially the shape of a cylindrical casing, wherein rectangular or approximately rectangular cage pockets 8 are located in a section of full wall thickness designated with the reference symbol 7, wherein rolling elements 6 are guided in these pockets. A section designated with 9 of reduced wall thickness of the rolling bearing cage 5 connects integrally on the end side (at the left in the arrangement according to FIGS. 1 and 2) to the section 7 of full wall thickness (measured in the radial direction of the rolling bearing cage 5). The section 9 of reduced wall thickness projects, as can be seen from FIG. 1, in the axial direction, that is, on the end side of the rolling bearing cage 5, past the outer ring 2. Embodiments can also be realized in which the outer ring 2 connects flush with the rolling bearing cage 5 or projects past the rolling bearing cage 5.

While the outer side of the section 9 of reduced wall thickness is clearly offset inward in the radial direction compared with the outer circumference of the section 7 of full wall thickness, the inner, mainly cylindrical surface of the section 9 of reduced wall thickness transitions essentially smoothly into the inner, also mainly cylindrical surface of the section 7 of full wall thickness.

In contrast to the section 7 of full wall thickness, which has a significant mechanical function with guiding the rolling elements 6, the main function of the section 9 of reduced wall thickness is to feed lubricant, namely oil, within the rolling bearing 1. A feeding direction Z, in which oil is fed from the outside to the rolling bearing 1, is shown in FIG. 1 with wide, curled arrows. According to this idealized representation, the oil contacts the section 9 of reduced wall thickness on the inside, which is also designated, for short, as oil-collecting ring.

The other areas of the rolling bearing cage 5, which are designated collectively as section 7 of full wall thickness for differentiating from the oil-collecting ring 9, comprise two circumferential edge strips 10, 11, wherein the oil-collecting ring 9 directly contacts the edge strip 10 on the left in FIGS. 1 and 2 and only the second edge strip 11 forms an end-side sealing of the rolling bearing cage 5, as well as a number of different webs 12, 13 that connect the edge strips 10, 11 to each other and form the cage pockets 8. The entire rolling bearing cage 5, also called cage for short, is formed in one piece and from metal, in particular, steel or a non-ferrous metal alloy. In the case of a production from steel, the cage 5 is preferably provided, at least on tribologically loaded surfaces, with a coating, in particular, non-ferrous metal coating, which has better sliding properties in comparison to steel.

The oil located initially on the inner side of the oil-collecting ring 9 flows through different oil-guiding grooves 14, 15, 16, which will be discussed in more detail below, in order to provide oil to both the cage guiding surfaces that guide the cage 5 on the inner circumference of the rims 3, 4 and also the raceways, on one hand, of the outer ring 2 and, on the other hand, of a not-shown inner ring or an otherwise already present shaft.

The oil-guiding grooves 14, 15 that extend to different lengths in the axial direction are designated as oil-guiding grooves of the first type and open in all cases into a radial bore hole 17 that extends up to the outer circumference of the cage 5 and thus is used to lubricate the cage guiding surfaces. Here, the shorter oil-guiding grooves 14, also called oil-guiding grooves of the first sub-type, extend only up to the first edge strip 10 connecting to the oil-collecting ring 9, while the longer oil-guiding grooves 15, also called oil-guiding grooves of the second sub-type, extend past the inner side of each web 12 up to the second edge strip 11. The oil flowing through the radial bore holes 17 due to the centrifugal force produced by the rotation of the cage 5 is discharged in both axial directions as shown in FIG. 2 by two oppositely directed arrows out from the rolling bearing 1 at the sides between the cage 5 and the rims 3, 4, that is, at the cage guiding surfaces.

The webs 12 on whose inner side oil-guiding grooves 15 of the first type and second type are formed running in the axial direction like the webs 12 themselves are designated as non-reinforced webs. In contrast, the webs 13 arranged between two webs 12 in the circumferential direction each have an integrally formed, radially inward directed extension 18 and are therefore called reinforced webs.

Between a non-reinforced web 12 and a reinforced web 13 there is a cage pocket 8. An oil-guiding groove of the second type 16, which is formed like the oil-guiding grooves 14, 15 of the first type on the inner side of the cage 5 in its surface, leads into the pocket. In contrast to the oil-guiding grooves 14, 15 of the first type, the oil-guiding groove of the second type 16 does not open into a radial bore hole 17, but instead directly into the associated cage pocket 8. Thus, the oil-guiding groove of the second type 16 is used to supply lubricant to the rolling elements 6 and the raceways. Overall, through the combination of the oil-collecting ring 9 with the different oil-guiding grooves 14, 15, 16 and radial bore holes 17, this arrangement realizes a uniform supply of lubricant to all tribologically loaded surfaces within the rolling bearing and also very efficient heat dissipation.

### REFERENCE SYMBOLS

1 Rolling bearing
2 Outer ring
3 Rim
4 Rim
5 Rolling bearing cage
6 Rolling element
7 Section of full wall thickness
8 Cage pocket
9 Section of reduced wall thickness, oil-collecting ring
10 Edge strip
11 Edge strip
12 Web, non-reinforced
13 Web, reinforced
14 Oil-guiding groove of the first type, first sub-type
15 Oil-guiding groove of the first type, second sub-type
16 Oil-guiding groove of the second type
17 Radial bore hole
18 Extension
A Axis
Z Feeding direction

1. A rolling bearing cage for a radial bearing, comprising:
a) first and second circumferential edge strips that are connected to each other by webs to form cage pockets, wherein at least one of the edge strips has an end-side section formed as an oil-collecting ring of reduced wall thickness,
b) the cage pockets are each adapted to hold a rolling element,
c) oil-guiding grooves of a first type running on an inner circumference of at least one of the edge strips parallel to the webs, wherein a radial bore hole extends from each of said oil-guiding grooves to an outer circumference of the edge strip,
d) oil-guiding grooves of a second type running on the inner circumference of at least one of the edge strips, wherein each of said oil-guiding grooves of the second type extend from the oil-collecting ring to one of the cage pockets.

2. The rolling bearing cage according to claim 1, wherein the oil-guiding grooves of the first type each run in a same circumferential section as the web.

3. The rolling bearing cage according to claim 1, wherein the cage comprises a single oil-collecting ring.

4. The rolling bearing cage according to claim 3, wherein the oil-guiding grooves of the first type comprise oil-guiding grooves of a first sub-type and oil-guiding grooves of a second sub-type, wherein the oil-guiding grooves of the second sub-type are longer than the oil-guiding grooves of the first sub-type and the radial bore holes starting from the oil-guiding grooves of the first sub-type pass through one of the edge strips, and the radial bore holes starting from the oil-guiding grooves of the second sub-type pass through the second edge strip.

5. The rolling bearing cage according to claim 4, wherein individual ones of the webs are reinforced inward in a radial direction and other ones of the webs are not reinforced.

6. The rolling bearing cage according to claim 5, wherein the reinforced webs are each arranged in an axial extension of a respective one of the oil-guiding grooves of the first sub-type.

7. The rolling bearing cage according to claim 5, wherein one of the oil-guiding grooves of the second sub-type is arranged on the inner circumference of a non-reinforced one of the web.

8. The rolling bearing cage according to claim 7, wherein the webs that are reinforced and the webs that have an oil-guiding groove of the second sub-type alternate.

9. The rolling bearing cage according to claim 1, wherein the oil-guiding grooves of the different types differ from each other with regard to cross sections thereof.

10. The rolling bearing cage according to claim 9, wherein the oil-guiding grooves of the second type are formed for feeding a smaller quantity of lubricant than the oil-guiding grooves of the first type.

11. The rolling bearing cage according to claim 1, wherein the cage is formed for guiding cylindrical rollers, as rolling elements.

12. The rolling bearing cage according to claim 1, wherein the cage is guided on the outer rims.

13. The rolling bearing cage according to claim 1, wherein the cage is made from metal.

14. (canceled)
